(19) United States
(12) Patent Application Publication
(10) Pub. No.: US 2015/0211130 A1
(43) Pub. Date: Jul. 30, 2015

(54) ANTI-CORROSIVE AGENT FOR WASHING OF METAL WITH ACID, DETERGENT SOLUTION COMPOSITION, AND METHOD FOR WASHING OF METAL

(71) Applicant: NITTO BOSEKI CO., LTD, Fukushima-shi (JP)

(72) Inventors: Hiroyuki TAKAYAMA, Koriyama-shi (JP); Yasuhito NAKATA, Koriyama-shi (JP)

(21) Appl. No.: 14/683,380

(22) Filed: Apr. 10, 2015

Related U.S. Application Data
(62) Division of application No. 13/808,670, filed on Jan. 7, 2013.

(51) Int. Cl. C23G 1/02; B08B 3/08; C11D 1/88; B08B 3/02; C11D 11/00; C11D 3/00

(52) U.S. Cl. CPC C23G 1/02; C11D 11/0029; C11D 3/0073; C11D 1/88; B08B 3/02; B08B 3/08

(57) ABSTRACT

An anti-corrosive agent for washing of a metal with an acid, which comprises an amphoteric polymeric compound (P) having at least one cationic constituent unit (A) having a specific structure, at least one anionic constituent unit (B) having a specific structure and a specific sulfur-containing constituent unit (C).

### TECHNICAL FIELD

The present invention relates to an anti-corrosive agent for washing of a metal with an acid that is excellent in anti-corrosion effect and stability and its applications.

### BACKGROUND ART

Surfaces of the metals such as metal steel sheets have black oxide coating such as mill scale adhering thereon. For this reason, when a treatment such as an anti-corrosive treatment and plating is performed on metal steel sheet or the like in order to improve the performance of the final product, it is widely performed that the oxide coating is removed before the treatment, thereby giving anti-corrosiveness uniformly onto the surface of the steel sheet or improving adhesion between the surface of the steel sheet and plating coating or the like.

To remove scale or rust, acid washing using an acid detergent solution for a metal (hereinafter, also referred to as an “acid solution”) is usually performed. Examples of the acid detergent solution for a metal include aqueous solutions of inorganic acids such as sulfuric acid, hydrochloric acid and nitric acid; organic acids such as phosphoric acid, sulfamic acid, hydrofluoric acid, oxalic acid, citric acid, glycolic acid and formic acid; chelating agents such as ethylenediaminetetraacetic acid and mixtures thereof. As scale, rust and so on usually extremely strongly adhere to the surface of metal, the acid washing using the acid detergent solution for the metal needs a considerably long time to completely remove them. Moreover, when the acid washing is performed, not only the scale and rust but also the metallic substrate is dissolved and corroded. In this view, anti-corrosive agents to be added to the acid have been used in order to solve such a problem. For example, nitrogen-containing organic compounds are representative examples of such anti-corrosive agents.

As the nitrogen-containing organic compound used as an anti-corrosive agent, quaternary ammonium salts are known (for example, see Patent Document 1). As such quaternary ammonium salts, 1-vinyl-3-ethylimidazolinium bromide, 3-ethylbenzothiazolium bromide, ethyltriethanolammonium bromide and the like are used. It is known that, in addition to these quaternary ammonium salts, a nitrogen-containing organic compound other than the quaternary ammonium salts is concurrently used. For example, hexamethylenetetramine can be used (Patent Document 1). Such a nitrogen-containing organic compound has a detrimental effect of reducing the acid washing rate. Accordingly, when a nitrogen-containing organic compound of these is contained in an acid detergent solution for a metal, the acid washing time becomes further longer, and the deterioration in working efficiency cannot be avoided. Also, the anti-corrosion effect thereof is not sufficiently satisfying.

As the nitrogen-containing organic compound acting as the anti-corrosive agent, thiourea and derivatives thereof have also been proposed (for example, see Patent Document 2). Unfortunately, thiourea and derivatives thereof also have drawbacks similar to those of the quaternary ammonium salts.

Meanwhile, as the nitrogen-containing organic compound acting as an anti-corrosive agent, homopolymers of quaternary ammonium salt-substituted vinyl compounds and cationic polymers such as polyamine compounds having a cationic constituent unit and a sulfur dioxide unit (for example, see Patent Document 3) are known. Among these, the polyamine compounds have an anti-corrosion effect higher than that of the conventional nitrogen-containing organic compound, and are useful as an additive for the acid detergent solution for a metal. However, attempts to shorten the acid washing time for the efficiency in the acid washing have been made recently. For this reason, the content of the acid in the acid detergent solution for a metal has been increased, and therefore development of an anti-corrosive agent having a higher anti-corrosion effect has been demanded.

Moreover, in order to suppress the corrosion effectively, usage of a plurality of anti-corrosive agents for a metal in combination can be considered. In this case, the concentration ratio among the respective anti-corrosive agents changes along with the progress of the usage, and the anti-corrosion effect is likely to change, which may lead to fluctuation in the property of the final products.

Moreover, the copolymers having a cationic constituent unit and a sulfur dioxide unit currently in use may also change in the anti-corrosion effect as the concentration thereof changes. So, if the concentration of the anti-corrosive agent contained in the acid detergent solution for a metal using such a copolymer changes over the time, the problem of the fluctuation in the property of the final products may be caused therefrom.

### CITATION LIST

### Patent Literature

Patent Document 1: JP 61-037988 A
Patent Document 2: JP 11-050280 A
Patent Document 3: JP 2000-96049 A

### SUMMARY OF THE INVENTION

### Problems to be Solved by the Invention

In consideration of background arts, above, the present inventors attempted to develop an anti-corrosive agent for washing of a metal with an acid in which an anti-corrosion effect is high in acid washing of a surface of a metal, and change in an anti-corrosion effect is small even if the concentration of the anti-corrosive agent changes. As a result, unexpectedly, it was found that the problem can be solved by using an amphoteric polymer compound having a specific cationic constituent unit, a specific anionic constituent unit, and a constituent unit derived from sulfur dioxide. Namely, an object of the present invention is to provide an anti-corrosive agent for washing of a metal with an acid in which an anti-corrosion effect is high in acid washing of a surface of a metal, and change in an anti-corrosion rate is small even if the concentration of the anti-corrosive agent changes.

### Means for Solving the Problems

Namely, the present invention relates to any of (1) to (7) below:

(1) An anti-corrosive agent for washing of a metal with an acid, comprising an amphoteric polymer compound (P) having:

at least one cationic constituent unit (A) having a structure represented by the following structural formula (Ia) or (Ib), a structure corresponds to an inorganic acid salt or an organic acid salt thereof or a structure represented by the following structural formula (IIa) or (IIb):

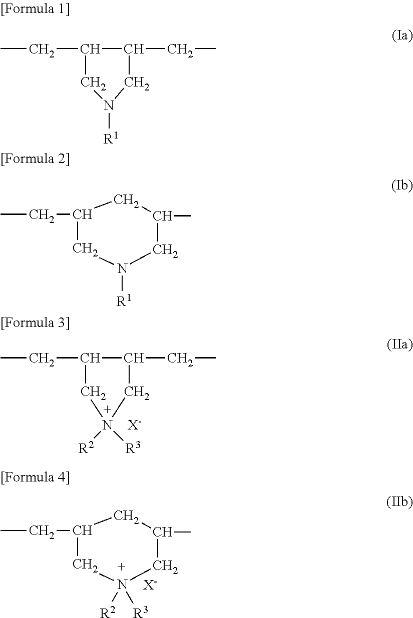

wherein R¹ in formulae (Ia) and (Ib), above, is hydrogen atom, methyl group, ethyl group, or benzyl group; R² and R³ in formulae (IIa) and (IIb), above, each independently are hydrogen atom, methyl group, ethyl group, or benzyl group; and X⁻ in formulae (IIa) and (IIb), above, is a counter ion;

at least one anionic constituent unit (B) represented by the following structural formula (III), (IV) or (V):

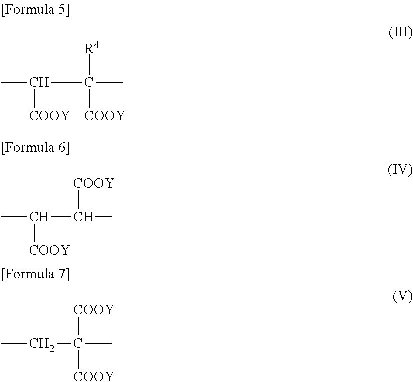

wherein R⁴ in formula (III), above, is hydrogen or methyl group; and Y in formulae (III), (IV) and (V), above, each independently are hydrogen, Na, K, NH₄, 1/2Ca, 1/2Mg, 1/2Fe, 1/3A1, or 1/3Fe for each carboxy group to which they are bonded; and

a constituent unit (C) represented by the following structural formula (VI):

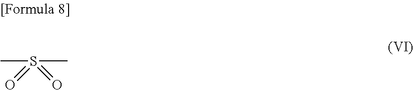

(2) The anti-corrosive agent according to (1), wherein the counter ion X⁻ is an anion derived from an organic acid or an inorganic acid.
(3) The anti-corrosive agent according to (1), wherein at least a part of the cationic constituent unit (A) is derived from a cationic monomer selected from the group consisting of diallylamines and inorganic acid salts and organic acid salts thereof.
(4) The anti-corrosive agent according to (1), wherein at least a part of the cationic constituent unit (A) is derived from diallyldimethylammonium chloride and at least part of the anionic constituent unit (B) is derived from maleic acid.
(5) An anti-corrosive agent for washing of a metal with an acid, comprising an amphoteric polymer compound (P′) obtainable by copolymerizing:

at least one monomer (α) having a structure represented by the following structural formula (VII), a structure corresponding to an inorganic acid salt or an organic acid salt thereof or a structure represented by the following structural formula (VIII):

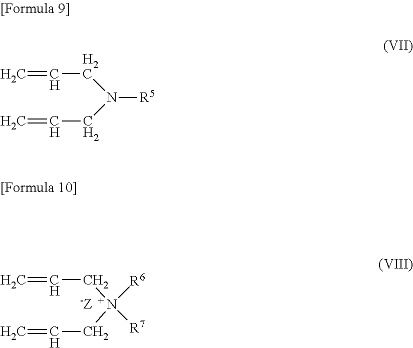

wherein R⁵ in formula (VII), above, is hydrogen atom, methyl group, ethyl group, or benzyl group; R⁶ and R⁷ in formula (VIII), above, each independently are hydrogen atom, methyl group, ethyl group, or benzyl group; and Z⁻ in formula (VIII), above, is a counter ion);

at least one monomer (β) selected from the group consisting of itaconic acid, citraconic acid, mesaconic acid, maleic acid, fumaric acid, methylenemalonic acid and compounds in which the hydrogens in the carboxyl groups in these acids are entirely or partially substituted with at least one species selected from the group consisting of Na, K, NH₄, 1/2Ca, 1/2Mg, 1/2Fe, 1/3A1, and 1/3Fe; and

sulfur dioxide.

(6) A detergent solution composition comprising an acid solution and an anti-corrosive agent according to any one of (1) to (5), wherein the content of the amphoteric polymer compound (P) or the amphoteric polymer compound (P′) is 0.1 to 50000 mg based on 1 L of the acid solution.
(7) A method for washing a metal, characterized in that the detergent solution composition according to (6) is sprayed to the surface of the metal or the surface of the metal is immersed in the detergent solution composition to carry out the washing.

### Advantages of the Invention

The anti-corrosive agent for washing of a metal with an acid according to the present invention can effectively suppress corrosion of a metal when the surface of the metal is acid washed. Additionally, in the anti-corrosive agent for washing of a metal with an acid according to the present invention, change in the anti-corrosion rate is extremely small even if the concentration of the anti-corrosive agent changes, and therefore quality of the final product can easily be kept constant. As a result, the anti-corrosive agent for washing of a metal with an acid according to the present invention makes great contribution to the development of a variety of industries such as the field of metal industries.

### DESCRIPTION OF EMBODIMENTS

Amphoteric Polymer Compound (P)

A first anti-corrosive agent for washing of a metal with an acid according to the present invention comprises an amphoteric polymer compound (P) having:
at least one cationic constituent unit (A) having a structure represented by the following structural formula (Ia) or (Ib), a structure corresponding to an inorganic acid salt or an organic acid salt thereof or a structure represented by the following structural formula (IIa) or (IIb):

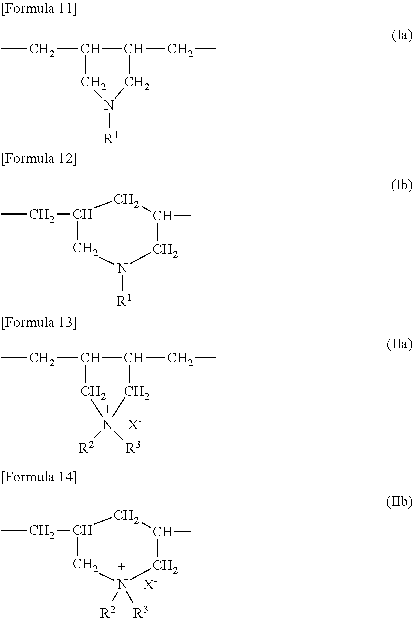

wherein R¹ in formulae (Ia) and (Ib), above, is hydrogen atom, methyl group, ethyl group, or benzyl group; R² and R³ in formulae (IIa) and (IIb), above, each independently are hydrogen atom, methyl group, ethyl group, or benzyl group; and X⁻ in formulae (IIa) and (IIb), above, is a counter ion;

at least one anionic constituent unit (B) represented by the following structural formula (III), (IV) or (V):

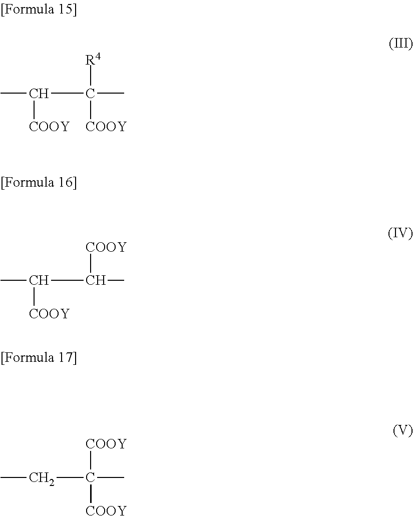

wherein R⁴ in formula (III), above, is hydrogen or methyl group and Y in formulae (III), (IV) and (V) each independently are hydrogen, Na, K, NH₄, 1/2Ca, 1/2Mg, 1/2Fe, 1/3A1, or 1/3Fe for each carboxy group to which they are bonded; and

a constituent unit (C) represented by the following structural formula (VI):

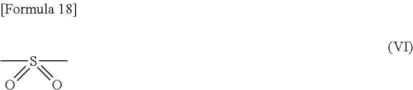

Here, “comprise” is used with an intention that the term includes both cases that the entirety of the first anti-corrosive agent for washing of a metal with an acid according to the present invention is constituted of the amphoteric polymer compound (P) and that a part of the first anti-corrosive agent for washing of a metal with an acid according to the present invention is constituted of the amphoteric polymer compound (P).

As long as the advantageous effects of the present invention are not impaired, the amphoteric polymer compound (P) used in the present invention may include a fourth constituent unit that is a constituent unit not corresponding to any of the cationic constituent unit (A), the anionic constituent unit (B) and the constituent unit (C), a constituent unit derived from a monomer such as monoallylamine and acrylamide for example. The constituent unit derived from a monomer such as monoallylamine and acrylamide may be included in a proportion of 15 mol % or less, preferably 10 mol % or less, and more preferably 5 mol % or less based on the total constituent units, for example.

In the amphoteric polymer compound (P), the molar ratio of cationic constituent units (A)/anionic constituent units (B) in the copolymerization is preferably 10/1 to 1/3, more preferably 8/1 to 1/2, and particularly preferably 6/1 to 1/1. In the amphoteric polymer compound (P), the molar ratio of the cationic constituent unit (A)/constituent unit derived from sulfur dioxide (C) in the copolymerization is preferably 1/1 to 1/0.01, more preferably 1.1/1 to 1/0.025, and particularly preferably 1.3/1 to 1/0.05. Furthermore, in the amphoteric polymer compound (P), the copolymerization ratio of the anionic constituent unit (B)/constituent unit derived from sulfur dioxide (C) is preferably 20/1 to 1/20, more preferably 15/1 to 1/15, and particularly preferably 10/1 to 1/10. The amphoteric polymer compound (P) usually has a molecular weight of 1,000 to 10,000,000, preferably 3,000 to 1,000,000, more preferably 5,000 to 100,000, still more preferably 10,000 to 50,000, and particularly preferably 15,000 to 30,000.

Cationic Constituent Unit (A)

The cationic constituent unit (A) that constitutes the amphoteric polymer compound (P) used in the present invention has a structure represented by the following structural formula (Ia) or (Ib), a structure corresponding to an inorganic acid salt or an organic acid salt thereof or a structure represented by the following structural formula (IIa) or (IIb).

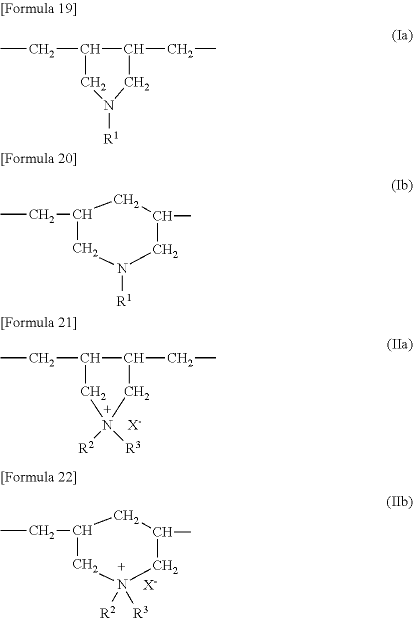

wherein R¹ in formulae (Ia) and (Ib), above, is hydrogen atom, methyl group, ethyl group, or benzyl group; R² and R³ in formulae (IIa) and (IIb), above, each independently are hydrogen atom, methyl group, ethyl group, or benzyl group and X⁻ in formulae (IIa) and (IIb), above, is a counter ion. X⁻ is preferably an anion derived from an organic acid or an inorganic acid, and particularly preferably a halogen ion (more preferably, Cl⁻, Br⁻, or I⁻), methylsulfuric acid ion, ethylsulfuric acid ion or acetate ion.

At least a part of the cationic constituent unit (A) is preferably derived from a cationic monomer selected from the group consisting of diallylamines and inorganic acid salts and organic acid salts thereof. At least a part of the cationic constituent unit (A) is particularly preferably a constituent unit derived from diallyldimethylammonium chloride.

In the amphoteric polymer compound (P), a single species of the cationic constituent unit (A) may solely be used, and more than one species of the cationic constituent units (A) each having a different structure may be used in combination.

In the case where more than one species of the cationic constituent units (A) each having a different structure are used in combination, each of the cationic constituent units may have different structures within the scope represented by the same general structural formula (Ia), (Ib), (IIa), or (IIb), or may have structures from different each other represented by different general structural formulae. In the former case, for example, more than one species of cationic constituent units (A) each represented by general structural formula (Ia) and having a different structure attributed to the difference in the structure of R¹ may be used in combination. In the latter case, for example, one cationic constituent unit (A) having a structure represented by structural formula (Ia), and another cationic constituent unit (A) having a structure represented by structural formula (IIa) may be used.

while the content of the cationic constituent unit (A) in the amphoteric polymer compound (P) is not particularly limited, the content preferably is an amount corresponding to the copolymerization molar ratio.

Anionic Constituent Unit (B)

The anionic constituent unit (B) that constitutes the amphoteric polymer compound (P) used in the present invention has a structure represented by the following structural formula (III), (IV), or (V).

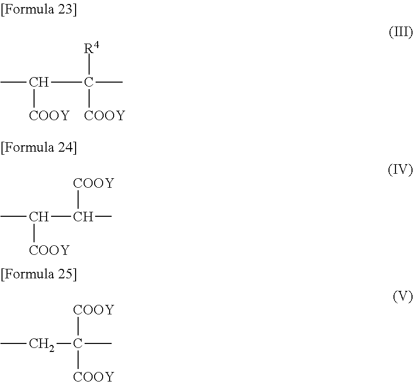

wherein R⁴ in formula (III), above, is hydrogen or methyl group; and Y in formulae (III), (IV) and (V), above, each independently is hydrogen, Na, K, NH₄, 1/2Ca, 1/2Mg, 1/2Fe, 1/3A1, or 1/3Fe for each carboxy group to which they are bonded.

In the amphoteric polymer compound (P), a single species of the anionic constituent unit (B) may solely be used, and more than one species of the anionic constituent units (B) each having a structure different from each other may be used in combination.

In the case where more than one species of the anionic constituent units (B) each having a structure different from each other are used in combination, each of the anionic constituent units may have a different structure within the scope represented by the same structural formula (III), (IV), or (V), or may have structures deferent from each other represented by different general structural formulae. In the former case, for example, more than one species of anionic constituent units (B) each represented by the formula (III) and having a different structure attributed to the difference in the element of Y may be used in combination. In the latter case, for example, one anionic constituent unit (B) having a structure represented by structural formula (III) and another anionic constituent unit (B) having a structure represented by structural formula (IV) may be used.

At least a part of the anionic constituent unit (B) is preferably derived from maleic acid. In this case, the anionic constituent unit (B) has a structure represented by the formula (IV) in which both Y are hydrogen.

While the content of the anionic constituent unit (B) in the amphoteric polymer compound (P) is not particularly limited, the content preferably is an amount corresponding to the aforementioned molar ratio in copolymerization.

Constituent Unit (C)

The constituent unit (C) that constitutes the amphoteric polymer compound (P) used in the present invention has a structure represented by the formula (VI):

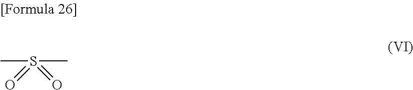

Usually, the constituent unit (C) can be introduced into the polymer by using sulfur dioxide as a monomer. While the content of the constituent unit (C) in the amphoteric polymer compound (P) is not particularly limited, it preferably is an amount corresponding to the aforementioned molar ratio the in copolymerization.

Usually, the amphoteric polymer compound (P) can be produced by copolymerizing a cationic monomer (α), an anionic monomer (β), described later, and sulfur dioxide. In this case, the copolymerization is quantitatively performed, and therefore the copolymerization ratio of the aforementioned constituent units (A), (B) and (C) is substantially the same as the ratio of the monomers (α), (β) and sulfur dioxide as charged.

Cationic Monomer (α)

In the production of the amphoteric polymer compound (P) used in the present invention, a specific cationic monomer (α) can be used to introduce the cationic constituent unit (A).

The cationic monomer (α) has a structure represented by the following structural formula (VII), a structure corresponding to an inorganic acid salt or an organic acid salt thereof or a structure represented by the following structural formula (VIII):

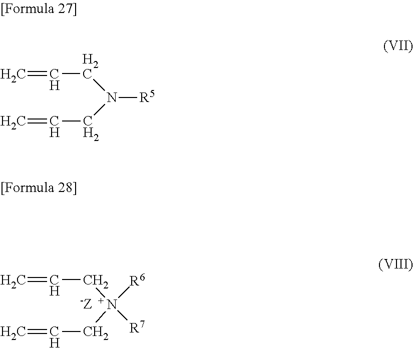

wherein R⁵ in formula (VII), above, is hydrogen atom, methyl group, ethyl group, or benzyl group; R⁶ and R⁷ in formula (VIII), above, each independently are hydrogen atom, methyl group, ethyl group, or benzyl group; and Z⁻ in formula (VIII), above, is a counter ion.

More specifically, examples of the cationic monomer (α) include diallylamines such as diallylamine, N-hydrocarbon group-substituted diallylamines and diallyldialkylammonium salts (namely, compounds having a diallylamine skeleton). Diallyldialkylammonium salts are preferable because the anti-corrosive agent is easily dissolved in the acid solution, and therefore the acid detergent solution composition can easily be prepared.

Examples of the N-hydrocarbon group-substituted diallylamines used in the present invention include N-methyldiallylamine, N-ethyldiallylamine and N-benzyldiallylamine.

In the case where the cationic monomer (α) is diallylamine or N-hydrocarbon group-substituted diallylamines, an inorganic acid salt, such as hydrochloric acid salts, sulfuric acid salts, nitric acid salts, and phosphoric acid salts, and an organic acid, salt such as acetic acid salts, of each amines may be used as a starting monomer for the copolymerization.

Examples of the diallyldialkylammonium salts used in the present invention include, but not limited to, chlorinated diallyldimethylammonium (diallyldimethylammonium chloride), diallyldimethylammonium bromide, diallyldimethylammonium iodide, diallyldimethylammonium methyl sulfate, diallyldimethylammonium ethyl sulfate, diallyldiethylammonium chloride, diallyldiethylammonium bromide, diallyldiethylammonium iodide, diallyldiethylammonium methyl sulfate, diallyldiethylammonium ethyl sulfate, diallylethylmethylammonium chloride, diallylethylmethylammonium bromide, diallylethylmethylammonium iodide, diallylethylmethylammonium methyl sulfate, diallylethylmethylammonium ethyl sulfate, diallylmethylbenzylammonium chloride, diallylmethylbenzylammonium bromide, diallylmethylbenzylammonium iodide, diallylmethylbenzylammonium methyl sulfate, diallylmethylbenzylammonium ethyl sulfate, diallylethylbenzylammonium chloride, diallylethylbenzylammonium bromide, diallylethylbenzylammonium iodide, diallylethylbenzylammonium methyl sulfate, diallylethylbenzylammonium ethyl sulfate, diallyldibenzylammonium chloride, diallyldibenzylammonium bromide, diallyldibenzylammonium iodide, diallyldibenzylammonium methyl sulfate, and diallyldibenzylammonium ethyl sulfate. Namely, in the formula (VIII), above, the combination of the groups R⁶ and R⁷ is preferably dimethyl, diethyl, ethylmethyl, dibenzyl, methylbenzyl, or ethylbenzyl, and the counter ion Z⁻ is preferably a halogen ion, methylsulfuric acid ion, or ethylsulfuric acid ion, though is not limited thereto.

Anionic Monomer (β)

In production of the amphoteric polymer compound (P) used in the present invention, anionic monomer (β) can be used to introduce the anionic constituent unit (B).

The anionic monomer (β) is a monomer selected from the group consisting of itaconic acid, citraconic acid, mesaconic acid, maleic acid, fumaric acid, and methylenemalonic acid, and compounds in which the hydrogens in the carboxyl groups in these acids are entirely or partially substituted with at least one species selected from the group consisting of Na, K, NH₄, 1/2Ca, 1/2Mg, 1/2Fe, 1/3A1, and 1/3Fe.

More preferably, as the anionic monomer (β), fumaric acid, maleic acid, citraconic acid, itaconic acid, a sodium salt thereof, a potassium salt thereof, an ammonium salt thereof or the like can be used.

Among the amphoteric polymer compounds (P) used in the present invention, a particularly preferable amphoteric polymer compound is a copolymer obtainable by using at least one of the diallyldimethylammonium salts as the cationic monomer (α) and copolymerizing the diallyldimethylammonium salt with at least one anionic monomer (β) selected from fumaric acid, maleic acid, itaconic acid, and citraconic acid and sulfur dioxide.

Production of Amphoteric Polymer Compound (P)

Next, a method for producing the amphoteric polymer compound (P) used in the present invention will be described. While the method for producing the amphoteric polymer compound (P) used in the present invention is not particularly limited, it is preferably produced according to the method described below.

First, the cationic monomer (α), the anionic monomer (β), and sulfur dioxide are mixed in a polar solvent. Next, in the polar solvent, the cationic monomer (α), the anionic monomer (β), and sulfur dioxide are subjected to a copolymerization reaction in the presence of a polymerization catalyst. The molar ratio of cationic monomer (α)/anionic monomer (β) is preferably 10/1 to 1/3, more preferably 8/1 to 1/2 and particularly preferably 6/1 to 1/1 as described above. The molar ratio of cationic monomer (α)/sulfur dioxide monomer is preferably 1/1 to 1/0.01, more preferably 1.1/1 to 1/0.025 and particularly preferably 1.3/1 to 1/0.05 as described above. The molar ratio of anionic monomer (β)/sulfur dioxide monomer is preferably 20/1 to 1/20, more preferably 15/1 to 1/15 and particularly preferably 10/1 to 1/10 as described above. Examples of the polar solvent can include water, methanol, ethanol, dimethyl sulfoxide, dimethylformamide and mixed solvents thereof. Among these, water is preferable from the viewpoint of polymerization reactivity and safety.

In the production of the amphoteric polymer compound (P) used in the present invention, as long as the advantageous effects of the present invention are not impaired, a fourth monomer that is a monomer not corresponding to any of the cationic monomer (α), the anionic monomer (β) and sulfur dioxide, such as monoallylamine and acrylamide may be used in a proportion of, for example 15 mol % or less, preferably 10 mol % or less, and more preferably 5 mol % or less based on the total monomers.

While the concentration of the monomer in the reaction solution during the polymerization of amphoteric polymer compound (P) varies depending on the species of the monomer, it is usually 10 to 75 mass %, preferably 30 to 70 mass %, and more preferably 50 to 65 mass %. The copolymerization reaction is usually a radical polymerization reaction performed in the presence of a radical polymerization catalyst. The kind of the radical polymerization catalyst is not particularly limited, and preferable examples thereof include peroxides such as t-butyl hydroperoxide; persulfates, such as ammonium persulfate, sodium persulfate, and potassium persulfate and water-soluble azo compounds such as azobis compounds and diazo compounds.

The amount of the radical polymerization catalyst to be added is usually 0.1 to 20 mol %, and preferably 1.0 to 10 mol %, based on the total monomers. The polymerization temperature is usually 0 to 100° C., and preferably 5 to 80° C. The polymerization time is usually 20 to 150 hours, and preferably 30 to 100 hours. The polymerization atmosphere may be in the air because polymerizability is not significantly affected. Alternatively, the polymerization can be performed under an atmosphere of an inert gas such as nitrogen.

Amphoteric Polymer Compound (P′)

A second anti-corrosive agent for washing of a metal with an acid according to the present invention comprises an amphoteric polymer compound (P′) obtainable by copolymerizing at least one species of the cationic monomers (α), at least one species of the anionic monomers (β) and sulfur dioxide. Here, the cationic monomer (α), the anionic monomer (β) and sulfur dioxide are the same as those described above. Moreover, “comprise” is used with the same intention as that described with respect to the first anti-corrosive agent for washing of a metal with an acid of the present invention. The amphoteric polymer compound (P′) may be that corresponding to the amphoteric polymer compound (P).

Anti-Corrosive Agent for Washing of Metal with Acid

The anti-corrosive agent for washing of a metal with an acid according to the present invention may be entirely constituted of the amphoteric polymer compound (P) or the amphoteric polymer compound (P′), or may be partially constituted of the amphoteric polymer compound (P) or the amphoteric polymer compound (P′). Accordingly, after the polymerization is completed, the amphoteric polymer compound (P) or the amphoteric polymer compound (P′) may be used as the anti-corrosive agent for washing of a metal with an acid of the present invention by using the solution after completion of the polymerization as it is. Alternatively, an organic solvent such as acetone may be added to the solution after completion of the polymerization to reprecipitate, solidify and use the compound as the anti-corrosive agent.

Detergent Solution Composition

The detergent solution composition of the present invention contains the anti-corrosive agent for washing of a metal with an acid of the present invention in an amount of usually 0.1 to 50000 mg, preferably 1 to 10000 mg, and more preferably 1 to 5000 mg based on 1 L of the acid solution in terms of a solid or pure compound of amphoteric polymer compound (P) or amphoteric polymer compound (P′). A necessary anti-corrosion effect can be obtained as the content is 0.1 mg or more based on 1 L of the acid solution. The anti-corrosion effect can be improved corresponding to the amount of the anti-corrosive agent for washing of a metal with an acid to be added as the content is 50000 mg or less.

While the acid used for the acid solution is not particularly limited, inorganic acids such as hydrochloric acid, sulfuric acid, sulfamic acid and hydrofluoric acid; organic acids such as formic acid, oxalic acid, citric acid, malic acid, hydroxyacetic acid and gluconic acid; and chelating agents such as ethylenediaminetetraacetic acid are preferable.

The anti-corrosive agent of the present invention may be added to the acid solution when it is used. Alternatively, it may be added to the acid solution in advance to prepare the detergent solution composition of the present invention and then be used directly or used following the dilution with water. Further, a surfactant or a solvent may be used in order to improve the mixing with the detergent solution. The surfactant or solvent used for this purpose may be mixed with the anti-corrosive agent of the present invention in advance, or may be added to the detergent solution composition of the present invention separately.

The anti-corrosive agent according to the present invention may be used in combination with another anti-corrosive agent. The other anti-corrosive agent may be mixed with the anti-corrosive agent of the present invention in advance, or may be added to the detergent solution composition of the present invention separately.

Specific examples of the other anti-corrosive agent used in combination include, but not limited to, 1-vinyl-3-ethylimidazolinium bromide, 3-ethylbenzothiazolium bromide and ethyltriethanolammonium bromide.

Further, in the detergent solution composition of the present invention, an acid washing accelerator, such as sulfites, for improving the acid washing rate may be used in combination.

Method for Washing of Metal

The method for washing of metal of the present invention is characterized in that the detergent solution composition of the present invention is sprayed to a surface of the metal or the surface of the metal is immersed in the detergent solution composition to wash the surface of the metal.

The detergent solution composition containing the anti-corrosive agent according to the present invention is sprayed to the surface of the metal to be washed or a metal piece to be washed is immersed in the detergent solution composition to wash the surface of the metal. While the metal to be washed is not particularly limited, the method is particularly effective when applied to steel.

### EXAMPLES

Hereinafter, the present invention will be described in detail with reference to Examples. The scope of the present invention will not be limited by these Examples in any meaning.

In Examples, the following abbreviations are used in some cases:

DADMAC: an abbreviation for diallyldimethylammonium chloride
MA: an abbreviation for maleic acid
SO₂: an abbreviation for sulfur dioxide
AMPS: an abbreviation for 2-acrylamide-2-methylpropanesulfonic acid
DA.HCl: an abbreviation for diallylaminehydrochloric acid salt

In Synthesis Examples, the weight average molecular weight and polymerization rate of the copolymer were measured by gel permeation chromatography (GPC) using a Hitachi L-6000 high speed liquid chromatograph. A Hitachi L-6000 was used as an eluent flow path pump, and a Shodex RI SE-61 differential refractive index detector was used as a detector. As a column, an Asahipak aqueous gel filtration type GS-220HQ (exclusion limit molecular weight of 3,000) and GS-620HQ (exclusion limit molecular weight of 2,000,000) were doubly connected and used. A sample was adjusted with an eluent to have a concentration of 0.5 g/100 mL, and 20 μL of the sample was used. As the eluent, a 0.4 mol/L sodium chloride aqueous solution was used. The measurement was performed at the column temperature of 30° C. and the flow rate of 1.0 mL/min Polyethylene glycols having the molecular weights of 106, 194, 440, 600, 1470, 4100, 7100, 10300, 12600, 23000, and the like were used as standard samples, and calibration curves were determined. Based on the calibration curves, the weight average molecular weight of the copolymer was determined.

### Synthesis Example 1

### Synthesis Example of 10:5:5 Ternary Copolymer of Diallyldimethylammonium Chloride, Maleic Acid and Sulfur Dioxide

In a 500 mL four-necked separable flask equipped with a stirrer, a cooling pipe and a thermometer, 248.7 g (1.0 mol) of a 65 mass % of DADMAC aqueous solution, 58.0 g (0.5 mol) of MA and 32.0 g (0.5 mol) of SO₂ were dissolved in 80.8 g of water. Then, 67.1 g of a 28.5 mass % of ammonium persulfate aqueous solution (7.6 mass % based on the monomer; 4.2 mol % based on the total monomers) was added, and polymerization was performed at 18 to 70° C. for 72 hours to synthesize the copolymer specified in the title and to be used in Example 1. The solution after the completion of the polymerization was measured by the GPC method to reveal that the weight-average molecular weight was 23,000 and the polymerization rate was 100%.

### Synthesis Examples 2 to 4

### Synthesis Examples of Ternary Copolymer of Diallyldimethylammonium Chloride, Maleic Acid and Sulfur Dioxide Having Various Copolymerization Ratios

The copolymers specified in the title an to be used in Examples 2 to 4 were synthesized by the same operation as that in Synthesis Example 1 except that the copolymerization ratio of diallyldimethylammonium chloride, maleic acid and sulfur dioxide was changed as below. In Synthesis Example 2 (copolymerization ratio of 10:4:1), the weight-average molecular weight was 24,000 and the polymerization rate was 100%. In Synthesis Example 3 (copolymerization ratio of 10:3.5:1.5), the weight-average molecular weight was 23,000 and the polymerization rate was 100%. In Synthesis Example 4 (copolymerization ratio of 10:2:3), the weight-average molecular weight was 23,000 and the polymerization rate was 100%.

### Comparative Synthesis Example 1

### Synthesis Example of 1:1 Binary Copolymer of Diallyldimethylammonium Chloride and Maleic Acid

In a 500 mL four-necked separable flask equipped with a stirrer, a cooling pipe and a thermometer, 116.1 g (1.0 mol) of MA was dissolved in 248.7 g (1.0 mol) of 65 mass % DADMAC aqueous solution, and the internal temperature was raised to 50° C. After the temperature was stabilized, 67.1 g of a 28.5 mass % ammonium persulfate aqueous solution was added to the obtained dissolution solution, and polymerization was performed at 50 to 70° C. for 72 hours to synthesize the copolymer specified in the title and to be used in Comparative Example 1. The solution after the completion of the polymerization was measured by the GPC method to reveal that the weight average molecular weight was 11,800 and the polymerization rate was 100%.

### Comparative Synthesis Example 2

### Synthesis Example of 2:1 Binary Copolymer of Diallyldimethylammonium Chloride and Maleic Acid

The copolymer specified in the title and to be used in Comparative Example 2 was produced by the same operation as that in Comparative Synthesis Example 1 except that the copolymerization ratio of diallyldimethylammonium chloride and maleic acid was changed. The weight average molecular weight was 24,000, and the polymerization rate was 100%.

### Comparative Synthesis Example 3

### Synthesis Example of 10:5:5 Ternary Copolymer of Diallyldimethylammonium Chloride:2-Acrylamide-2-Methylpropanesulfonic Acid and Sulfur Dioxide

In a 500 mL four-necked separable flask equipped with a stirrer, a cooling pipe and a thermometer, 248.7 g (1.0 mol) of 65 mass % DADMAC aqueous solution, 103.6 g (0.5 mol) of AMPS and 32.0 g (0.5 mol) of SO₂ were dissolved in 242.3 g of water. Then, 67.1 g of 28.5 mass % ammonium persulfate aqueous solution was added, and polymerization was performed at 18 to 70° C. for 72 hours to produce the copolymer specified in the title and to be used in Comparative Example 3. The solution after the completion of the polymerization was measured by the GPC method to reveal that the weight-average molecular weight was 11,500 and the polymerization rate was 95.0%.

### Comparative Synthesis Example 4

### Synthesis Example of 1:1 Binary Copolymer of Diallylaminehydrochloric Acid Salt and Sulfur Dioxide

In a 500 mL four-necked separable flask equipped with a stirrer, a cooling pipe and a thermometer, 202.5 g (1.0 mol) of 66 mass % DA.HCl and 64.1 g (1.0 mol) of SO₂ were dissolved in 206.7 g of water. Then, 13.7 g of 28.5 mass % ammonium persulfate aqueous solution was added, and polymerization was performed at 18 to 60° C. for 24 hours to produce the copolymer specified in the title and to be used in Comparative Example 4. The solution after the completion of the polymerization was measured by the GPC method to reveal that the weight average molecular weight was 5,000 and the polymerization rate was 96.0%.

### Comparative Synthesis Example 5

### Synthesis Example of 1:1 Binary Copolymer of Diallyldimethylammonium Chloride and Sulfur Dioxide

In a 500 mL four-necked separable flask equipped with a stirrer, a cooling pipe and a thermometer, 248.7 g (1.0 mol) of 65 mass % DADMAC and 64.1 g (1.0 mol) of SO₂ were dissolved in 210.0 g of water. Then, 16.5 g of 28.5 mass % ammonium persulfate aqueous solution was added, and polymerization was performed at 18 to 60° C. for 72 hours to produce the copolymer specified in the title and to be used in Comparative Example 5. The solution after the completion of the polymerization was measured by the GPC method to reveal that the weight-average molecular weight was 4,200 and the polymerization rate was 95.0%.

### Examples 1 to 4 and Comparative Examples 1 to 6

Measurement of Solubility, Amount of Corrosion, Corrosion Suppression Rate, and performance deterioration rate

With respect to each of the copolymers obtained in Synthesis Examples and Comparative Synthesis Examples, above, a detergent solution composition was prepared by the following method and evaluated.

### (Preparation of Detergent Solution Composition)

To 500 mL of a detergent solution aqueous solution comprising a 3.5 mass % hydrochloric acid aqueous solution (hereinafter, referred to an “acid solution”), each of the copolymers produced in Synthesis Examples and Comparative Synthesis Examples (that constitutes the anti-corrosive agent according to the present invention) was added in an amount of 50 mg or 1000 mg (in terms of the solid content) according to Table 1 to obtain a detergent solution composition.

### (Solubility)

In the preparation of the detergent solution composition, above, the state of the solution when the anti-corrosive agent was added to the detergent solution aqueous solution was visually observed to evaluate the solubility. The state in which turbidity was recognized was classified as “turbid”, and the state of complete dissolution without turbidity was classified as “not turbid”.

### (Amount of Corrosion)

The detergent solution composition prepared by the method, above, was heated to 80° C. Then, a hot-rolled steel sheet (JIS3131) polished with a #180 waterproof polishing paper was immersed in the detergent solution composition for 10 minutes. From the surface area of the test piece and measurement results of the weight of the test piece before and after the immersion, the amount of corrosion was calculated according to the following expression (1).

amount of corrosion (mg/cm²)=[weight of test piece before immersion (mg)−weight of test piece after immersion (mg)]/surface area of test piece (cm²) (1)

### (Corrosion Suppression Rate)

From the result of the amount of corrosion calculated according to the expression (1), the corrosion suppression rate was calculated according to the following expression (2).

anti-corrosion rate (%)=[amount of corrosion in Comparative Example 6 (mg/cm²)−amount of corrosion in each Example or Comparative Example (mg/cm²)]×100/amount of corrosion in Comparative Example 6 (mg/cm²) (2)

### (Performance Deterioration Rate)

From the corrosion suppression rate when the amount of the anti-corrosive agent added was 1000 mg and the corrosion suppression rate when the amount of the anti-corrosive agent added was 50 mg, the performance deterioration rate was calculated according to the following expression (3).

performance reducing rate (%)=100−A (3)

(A=(corrosion suppression rate when the amount of the anti-corrosive agent added was 1000 mg (%)×100)/corrosion suppression rate when the amount of the anti-corrosive agent added was 50 mg (%))

The results are shown in Table 1. The result of the test performed using only the acid solution with no anti-(acid) corrosive agent added is also shown in Table 1 as “Blank” (Comparative Example 6).

With reference to Table 1, it turned out that the anti-corrosive agent for washing of a metal with an acid according to the present invention has high solubility in the acid solution. Additionally, it turned out that the anti-corrosive agent for washing of a metal with an acid according to the present invention has a high corrosion suppression rate both in the concentrations of the added amounts of 50 mg and 1000 mg and furthermore that the corrosion suppression rate changes little even when the concentration changes and that the performance deterioration rate is small.

TABLE 1
Results of test of anti-corrosion in acid washing

| | | | | | | Amount | | |
|---|---|---|---|---|---|---|---|---|
| | | | Copoly- | | | of | corrosion | Performance |
| | | Name of sample | merization | Amount | | corrosion | suppression | deterioration |
| | | (Synthesis Example) | ratio | added [mg] | Solubility | [mg/cm²] | rate [%] | rate [%] |
| Example | 1 | P (DADMAC-MA-SO₂) | 10:5:5 | 50 | Not turbid | 0.114 | 91.5 | 2.52 |
| | | (Synthesis Example 1) | | 1000 | Not turbid | 0.145 | 89.2 | |
| | 2 | P (DADMAC-MA-SO₂) | 10:4:1 | 50 | Not turbid | 0.157 | 88.3 | 2.61 |
| | | (Synthesis Example 2) | | 1000 | Not turbid | 0.188 | 86.0 | |
| | 3 | P (DADMAC-MA-SO₂) | 10:3.5:1.5 | 50 | Not turbid | 0.176 | 86.9 | 2.65 |
| | | (Synthesis Example 3) | | 1000 | Not turbid | 0.207 | 84.6 | |
| | 4 | P (DADMAC-MA-SO₂) | 10:2:3 | 50 | Not turbid | 0.163 | 87.9 | 2.62 |
| | | (Synthesis Example 4) | | 1000 | Not turbid | 0.194 | 85.6 | |
| Comparative | 1 | P (DADMAC-MA) | 1:1 | 50 | Not turbid | 0.274 | 79.6 | 2.90 |
| Example | | (Comparative Synthesis | | 1000 | Not turbid | 0.305 | 77.3 | |
| | | Example 1) | | | | | | |
| | 2 | P (DADMAC-MA) | 2:1 | 50 | Not turbid | 0.252 | 81.3 | 3.02 |
| | | (Comparative Synthesis | | 1000 | Not turbid | 0.285 | 78.8 | |
| | | Example 2) | | | | | | |
| | 3 | P (DADMAC-AMPS-SO₂) | 10:5:5 | 50 | Not turbid | 0.203 | 84.9 | 4.99 |
| | | (Comparative Synthesis | | 1000 | Not turbid | 0.260 | 80.7 | |
| | | Example 3) | | | | | | |
| | 4 | P (DA-HCl-SO₂) | 1:1 | 50 | Not turbid | 0.094 | 93.0 | 13.97 |
| | | (Comparative Synthesis | | moo | Turbid | 0.269 | 80.0 | |
| | | Example 4) | | | | | | |
| | 5 | P (DADMAC-SO₂) | 1:1 | 50 | Not turbid | 0.141 | 89.5 | 25.68 |
| | | (Comparative Synthesis | | 1000 | Not turbid | 0.450 | 66.5 | |
| | | Example 5) | | | | | | |
| | 6 | Blank | — | — | — | 1.345 | — | — |

In Table 1, the following abbreviations are used:
P(DADMAC-MA-SO₂): poly(diallyldimethylammonium chloride/maleic acid/SO₂)
P(DADMAC-MA): poly(diallyldimethylammonium chloride/maleic acid)
P(DADMAC-AMPS-SO₂): poly(diallyldimethylammonium chloride/2-acrylamide-2-methylpropanesulfonic acid/SO₂)
P(DA•HCl-SO₂): poly(diallylamine hydrochloric acid salt/SO₂)
P(DADMAC-SO₂): poly(diallyldimethylammonium chloride/SO₂)

### INDUSTRIAL APPLICABILITY

The anti-corrosive agent for washing of a metal with an acid according to the present invention and the detergent solution composition and washing method using the same demonstrate a high anti-corrosion effect in acid washing of various surfaces of metals and show little change in the anti-corrosion effect even when the concentration of the anti-corrosive agent changes. Accordingly, the present invention is highly valuable and has high applicability in a variety of industries such as the metal industries.

1-6. (canceled)

7. A method for washing a metal, characterized in that a detergent solution composition comprising an acid solution and an anti-corrosive agent is sprayed to the surface of the metal or the surface of the metal is immersed in the detergent solution composition to carryout the washing,
wherein the anti-corrosive agent comprises an amphoteric polymer compound (P) having: at least one cationic constituent unit (A) having a structure represented by the following structural formula (Ia) or (Ib), a structure corresponds to an inorganic acid salt or an organic acid salt thereof or a structure represented by the following structural formula (IIa) or formula (IIb): 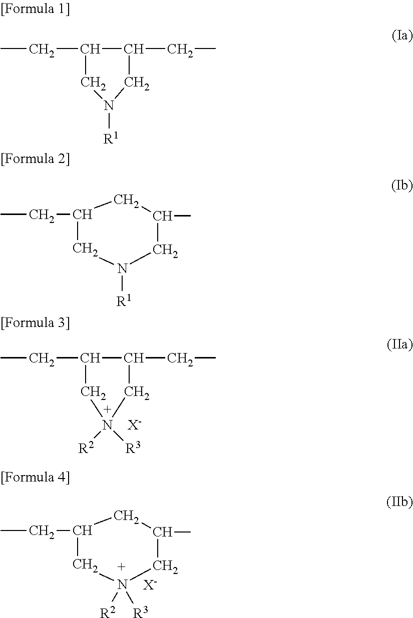
wherein R¹ in formulae (Ia) and (Ib), above, is hydrogen atom, methyl group, ethyl group, or benzyl group; R² and R³ in formulae (IIa) and (IIb), above, each independently are hydrogen atom, methyl group, ethyl group, or benzyl group; and X⁻ in formulae (IIa) and (IIb), above, is a counter ion;
at least one anionic constituent unit (B) represented by the following structural formula (III), (IV) or (V): 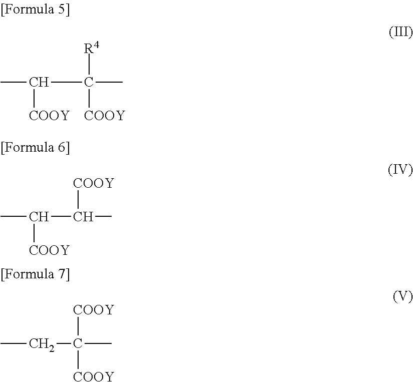
wherein R⁴ in formula (III), above, is hydrogen or methyl group; and Y in formulae (III), (IV) and (V) each independently are hydrogen, Na, K, NH₄, 1/2Ca, 1/2Mg, 1/2Fe, 1/3A1, or 1/3Fe for each carboxy group to which they are bonded); and
a constituent unit (C) represented by the following structural formula (VI): 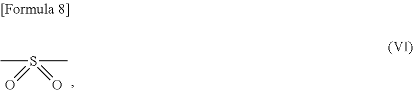
and wherein the content of the amphoteric polymer compound (P) is 0.1 to 50000 mg based on 1 L of the acid solution.

8. The method according to claim 1, wherein the counter ion X⁻ is an anion derived from an organic acid or an inorganic acid.

9. The method according to claim 1, wherein at least a part of the cationic constituent unit (A) is derived from a cationic monomer selected from the group consisting of diallylamines and inorganic acid salts and organic acid salts thereof.

10. The method according to claim 1, wherein at least a part of the cationic constituent unit (A) is derived from diallyldimethylammonium chloride and at least a part of the anionic constituent unit (B) is derived from maleic acid.

11. A method for washing a metal, characterized in that a detergent solution composition comprising an acid solution and an anti-corrosive agent is sprayed to the surface of the metal or the surface of the metal is immersed in the detergent solution composition to carry out the washing,
wherein the anti-corrosive agent comprises an amphoteric polymer compound (P′) obtainable by copolymerizing:
at least one monomer (cc) having a structure represented by the following structural formula (VII), a corresponds to an inorganic acid salt or an organic acid salt thereof or a structure represented by the following structural formula (VIII): 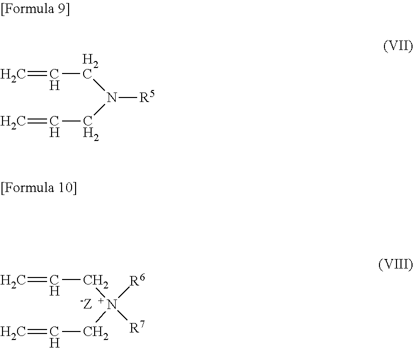
wherein R⁵ in formula (VII), above, is hydrogen atom, methyl group, ethyl group, or benzyl group; R⁶ and R⁷ in formula (VIII), above, each independently are hydrogen atom, methyl group, ethyl group, or benzyl group; and Z⁻ in formula (VIII), above, is a counter ion);
at least one monomer (β) selected from the group consisting itaconic acid, citraconic acid, mesaconic acid, maleic acid, fumaric acid, methylenemalonic acid, and compounds in which the hydrogens in the carboxyl groups in these acids are entirely or partially substituted with at least one species selected from the group consisting of Na, K, NH₄, 1/2Ca, 1/2Mg, 1/2Fe, 1/3A1, and 1/3Fe; and
sulfur dioxide, and
wherein the content of the amphoteric polymer compound (P′) is 0.1 to 50000 mg based on 1 L of the acid solution.
